(19) United States
(12) Patent Application Publication
(10) Pub. No.: US 2005/0203286 A1
(43) Pub. Date: Sep. 15, 2005

(54) Environmental protection series of reactive dyestuffs and their use

(75) Inventors: Hsiao-San Chen, Lujhu Township (TW); Jia-Cheng Hsu, Kaohsiung City (TW); Chia-Huei Yu, Dongshan Township (TW)

Correspondence Address: BACON & THOMAS, PLLC, 625 SLATERS LANE, FOURTH FLOOR, ALEXANDRIA, VA, 22314, US

(73) Assignee: Everlight USA, Inc., Pineville, NC (US)

(21) Appl. No.: 10/902,930

(22) Filed: Aug. 2, 2004

(30) Foreign Application Priority Data
Mar. 12, 2004 (CN) 200410039665X

(51) Int. Cl. C09B 44/08

(52) U.S. Cl. 534/605

(57) ABSTRACT

An environmental protection reactive dyestuff of the following formula (I) is disclosed, 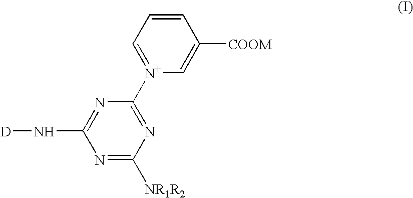
wherein R₁, R₂, D, M are defined as in the specification. The dyestuff of the invention is distinguished by a high fixation and a very good build-up. It is distinguished also by a green environmental protection and a low salt, a low base, a high exhaustion, non-contain heavy metal and halogen atoms, and it has fiber-reactive properties and is very highly suitable for dyeing and printing of materials containing either cellulose fibers, such as cotton, synthetic cotton, hemp, and synthetic hemp, or amide containing fibers such as wool and nylon.

### BACKGROUND OF THE INVENTION

1. Field of the Invention

The present invention relates to a kind of fiber-reactive dye, more particularly, a low-salt, low-base containing, and environmental protection reactive azo dye, suitable for dyeing and printing of cellulose fiber materials in water bath.

2. Description of Related Art

The U.K. patent number 1,110,567, has already disclosed the reactive dyestuff of formula (II-A) but the build-up and fixation properties of this compound are not promising.

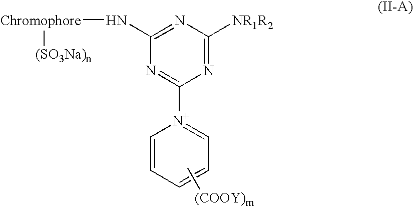

The preparation and application in dyeing of the formula (II-B) is disclosed in Japanese patent number 52,018,732. 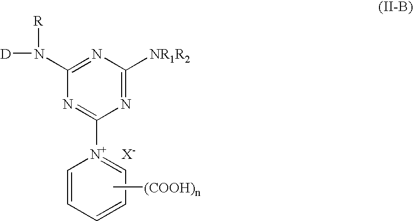
This dyestuff has higher reactivity, less base requirement, and could be used in T/C one-way bath dyeing. 5 The European patent number 418,623, has disclosed the preparation method of the following formula (II-C) by introducing sulfo group on pyridine to increase water solubility and to use in T/C one-way bath dyeing.

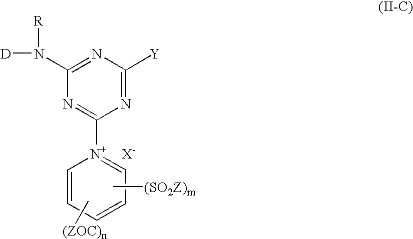

Also, the preparation method of the formula (II-D) and (II-E) is disclosed in Japanese patent number 2,534,909. First introducing a pyridinyl quaternary triazine group and then adding a chromophore group form the reactive dyestuff. As in T/C one-way bath dyeing, it has improved the properties of light-fastness and chlorine bleaching.

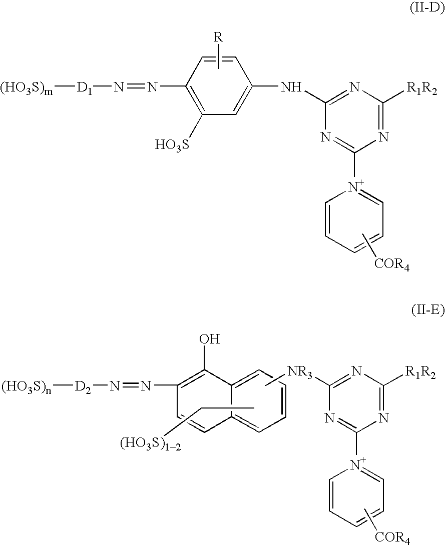

In the development of the dyestuff market, it is now moving toward environmental protection dyestuff. Generally speaking, an environmental protection dyestuff is to maintain the fixation and exhaustion properties while satisfying the need of less energy and material consuming, low pollution, and also biodegradable. Still there are no products fulfill all these requirements.

The present invention provides an environmental protection dyestuff without containing heavy metal and halogen atoms. In dyeing condition, it has to be low salt, low base, and reduced pollution to environment.

The dyestuff of the present invention has good properties in washing off, biodegradable, build-up, light fastness and wash fastness. The dyestuff of the present invention also shows good properties of combination and levelness.

### SUMMARY OF THE INVENTION

The present invention provides an environmental protection reactive dyestuff of the following formula (I) and its application. 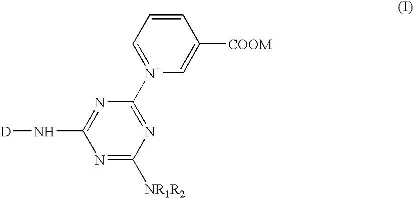
wherein
R₁ is H, C₁₋₄ alkyl, a phenyl group unsubstituted or substituted by one or more substituents, or a naphthyl group unsubstituted or substituted by one or more substituents; preferably the substituents of the phenyl group and the naphthyl group are selected from the group consisting of carboxyl group, sulfo group, —NHCOCH₃, —NHCONH₂, —NHCH₂CH₂COOH, methoxyl group, —SO₂CH═CH₂, —SO₂CH₂CH₂OSO₃H or —SO₂CH₂CH₂Cl; preferably R₁ is H or C₁₋₄ alkyl;
R₂ is H, C₁₋₄ alkyl, a phenyl group unsubstituted or substituted by one or more substituents, or a naphthyl group unsubstituted or substituted by one ore more substituents; preferably R₂ is a phenyl group unsubstituted or substituted, or a naphthyl group unsubstituted or substituted, wherein preferably the substituents of the phenyl group and the naphthyl group are selected from the group consisting of carboxyl group, sulfo group, —NHCOCH₃, —NHCONH₂, —NHCH₂CH₂COOH, methoxyl group, —SO₂CH═CH₂, —SO₂CH₂CH₂OSO₃H or —SO₂CH₂CH₂Cl;
M is H or an alkali metal;
D is a chromophore selected from the group consisting of: 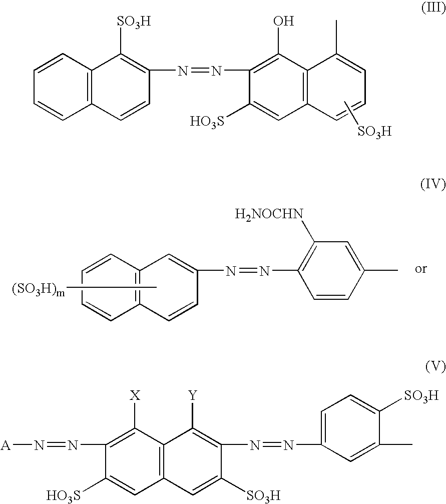
wherein
m is 2 or 3;
X and Y are different and each is independently amino group or hydroxyl group,
A is 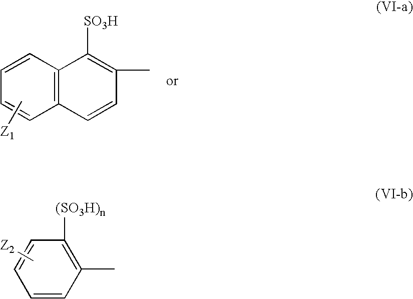
Z₁ is H, sulfo group, —SO₂CH═CH₂, —SO₂CH₂CH₂OSO₃H or —SO₂CH₂CH₂Cl;
Z₂ is H, nitro group, methoxyl group, sulfo group, —SO₂CH═CH₂, —SO₂CH₂CH₂OSO₃H, or —SO₂CH₂CH₂Cl;
n is 0 or 1.

The environmental protection reactive dyestuff of formula (I) of the present invention can exist as acid or salt, particularly for salts that are alkali metals or alkaline earth metals; in applications alkali metals are preferred.

Preferably the compound of formula (I) of the present invention is the following formula (Ia) 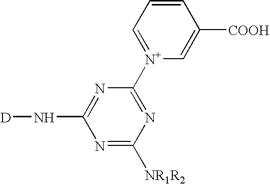
(Ia)
wherein R₁, R₂ and D are defined the same as the above formula (I) compound.

More preferably, the compounds of formula (I) of the present invention are the following formula (Ib), (Ic), (Id) and (Ie). 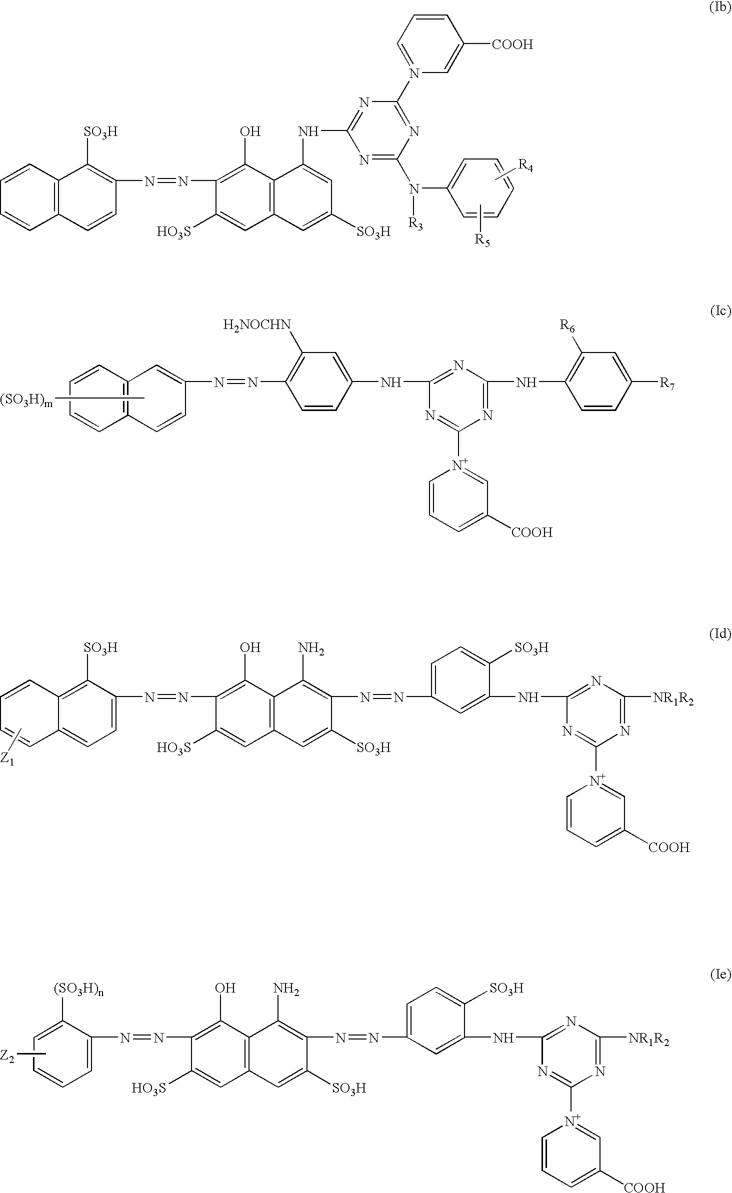
wherein:
R₁ is H, C₁₋₄ alkyl, a phenyl group unsubstituted or substituted by one or more substituents, or a naphthyl group unsubstituted or substituted by one or more substituents; preferably the substituents of the phenyl group and the naphthyl group are selected from the group consisting of carboxyl group, sulfo group, —NHCOCH₃, —NHCONH₂, —NHCH₂CH₂COOH, methoxyl group, —SO₂CH═CH₂, —SO₂CH₂CH₂OSO₃H or —SO₂CH₂CH₂Cl; preferably R₁ is H or C₁₋₄alkyl;
R₂ is H, C₁₋₄ alkyl, a phenyl group unsubstituted or substituted by one or more substituents, or a naphthyl group unsubstituted or substituted by one ore more substituents; preferably the substituents of the phenyl group and the naphthyl group are selected from the group consisting of carboxyl group, sulfo group, —NHCOCH₃, —NHCONH₂, —NHCH₂CH₂COOH, methoxyl group, —SO₂CH═CH₂, —SO₂CH₂CH₂OSO₃H or —SO₂CH₂CH₂Cl;
R₃ is H or C₁₋₄ alkyl, and preferably is H;
R₄ and R₅ each independently is H, methyl, ethyl, methoxyl, ethoxyl, chloro, bromo, nitro, carboxyl, sulfo, —NHCOCH₃, —NHCONH₂ or —NHCH₂CH₂COOH;
R₆ is H, carboxyl group, sulfo group, —NHCOCH₃, —NHCONH₂ or —NHCH₂CH₂COOH; and preferably is H, carboxyl group, sulfo group, or —NHCONH₂;
R₇ is H, methoxyl group, sulfo group, —SO₂CH═CH₂, —SO₂CH₂CH₂OSO₃H or —SO₂CH₂CH₂Cl; and preferably is H, sulfo group, or —SO₂CH₂CH₂OSO₃H;
Z₁ is H, sulfo group, —SO₂CH═CH₂, —SO₂CH₂CH₂OSO₃H or —SO₂CH₂CH₂Cl;
Z₂ is H, nitro group, methoxyl group, sulfo group, —SO₂CH═CH₂, —SO₂CH₂CH₂OSO₃H or —SO₂CH₂CH₂Cl;
m is 2 or 3; and
n is 0 or 1.

The present invention also relates to a method of dying or printing on cellulose fiber materials, which comprises the usage of the reactive dyestuff of formula (I) on cellulose fiber materials such as cotton.

### DETAILED DESCRIPTION OF THE PREFERRED EMBODIMENT

The reactive dyestuff of formula (I) of the present invention can be synthesized by conventional methods. Examples of the conventional methods are showing as below.

The compound of the formula (a) is reacted with trihalogen triazine of the following formula (b) 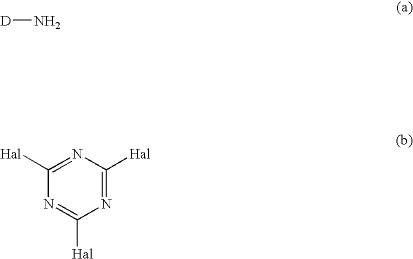
wherein, D is defined the same as the above reactive dyestuff of formula (I); Hal is halogen such as F, Cl, or Br atom, under low temperature (0-10° C.) and pH change from acidic to neutral (pH=3-7). The resulting compound can further undergoes condensation reaction with the following compound of formula (c)
NHR₁R₂ (c)
wherein, R₁ and R₂ are defined the same as the above reactive dyestuff of formula (I), under mild acid to base environment (pH=5-9) while the temperature is to be maintained between 20˜60° C.. Finally the reactive dyestuff of formula (I) is obtained by condensing the resulting compound with nicotinate compound of formula (d) under acidic to neutral environment (pH=3-7) with temperature at 60-100° C.

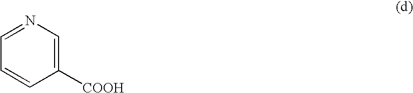

The reaction procedures of the compounds (a), (b), (c) and (d) in the above preparation method can be rearranged with respect to each other which also result in the same reactive dyestuff of formula (I).

Examples of the formula (a) are as below:

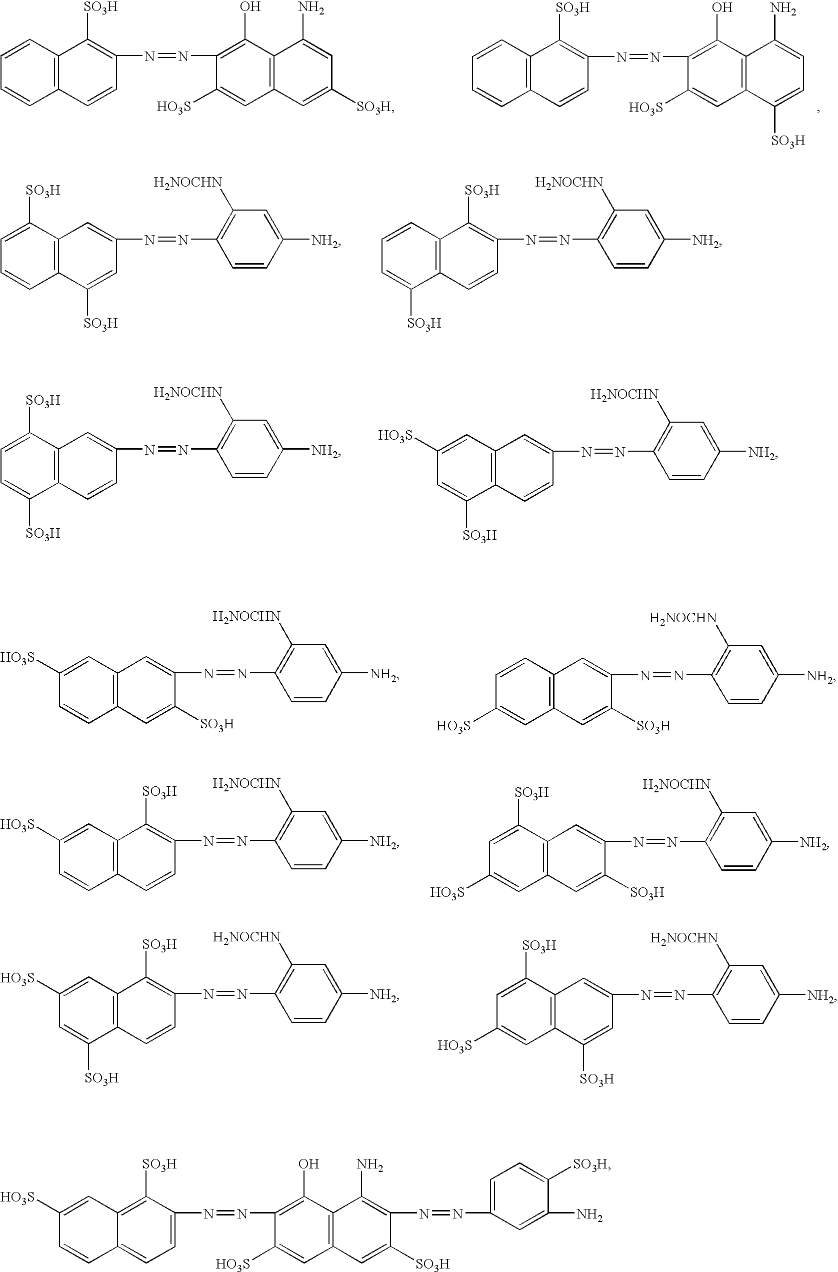

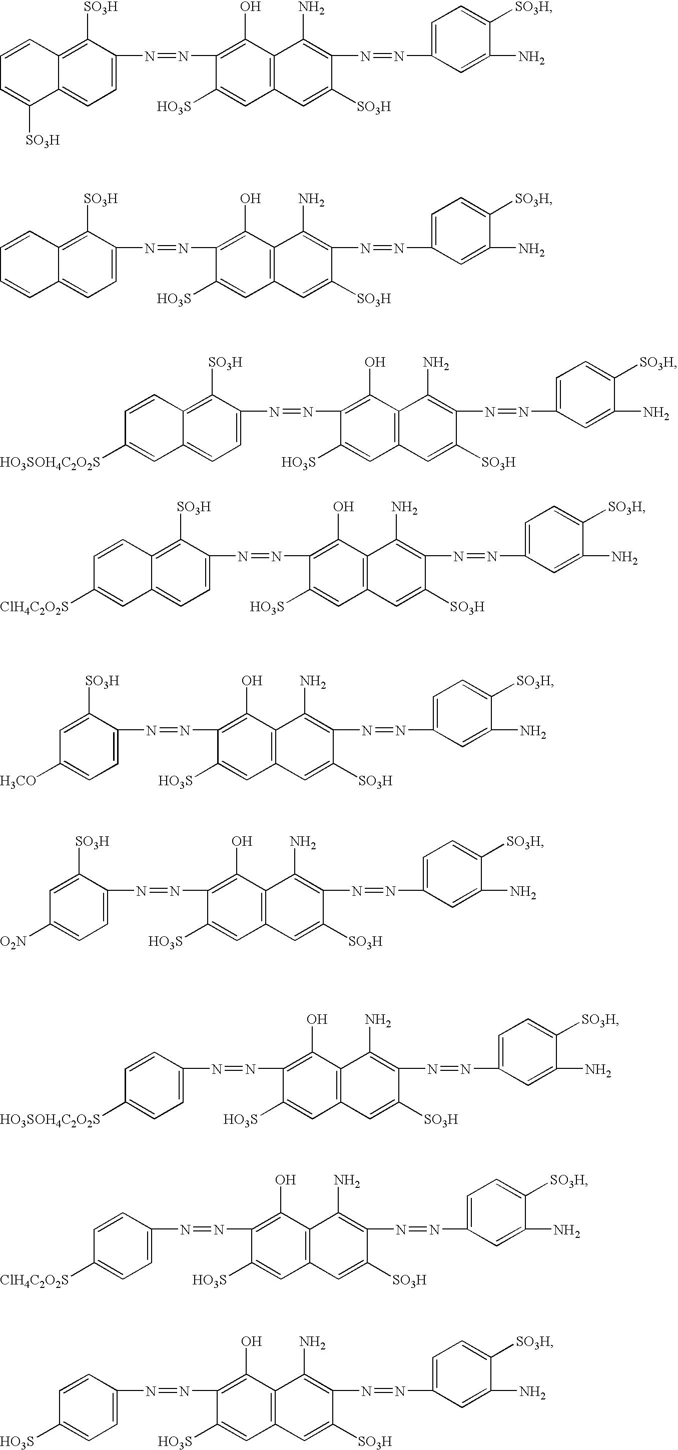

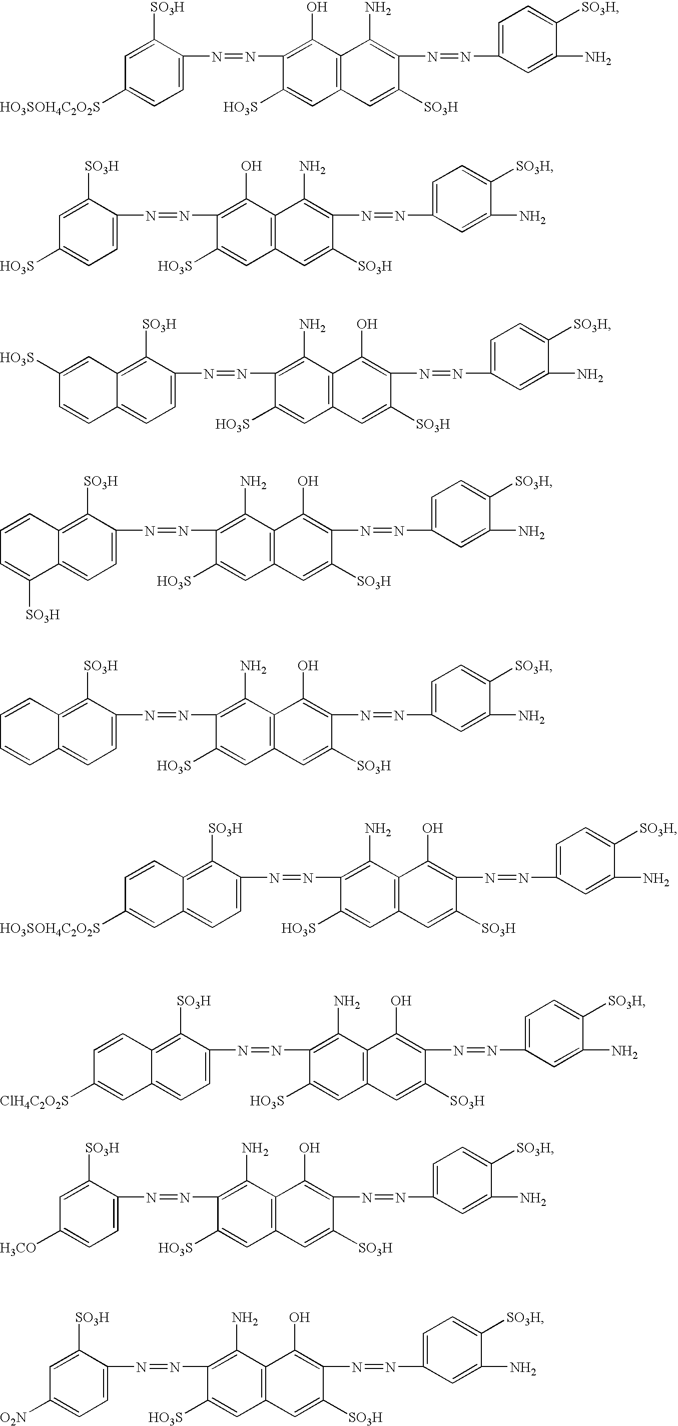

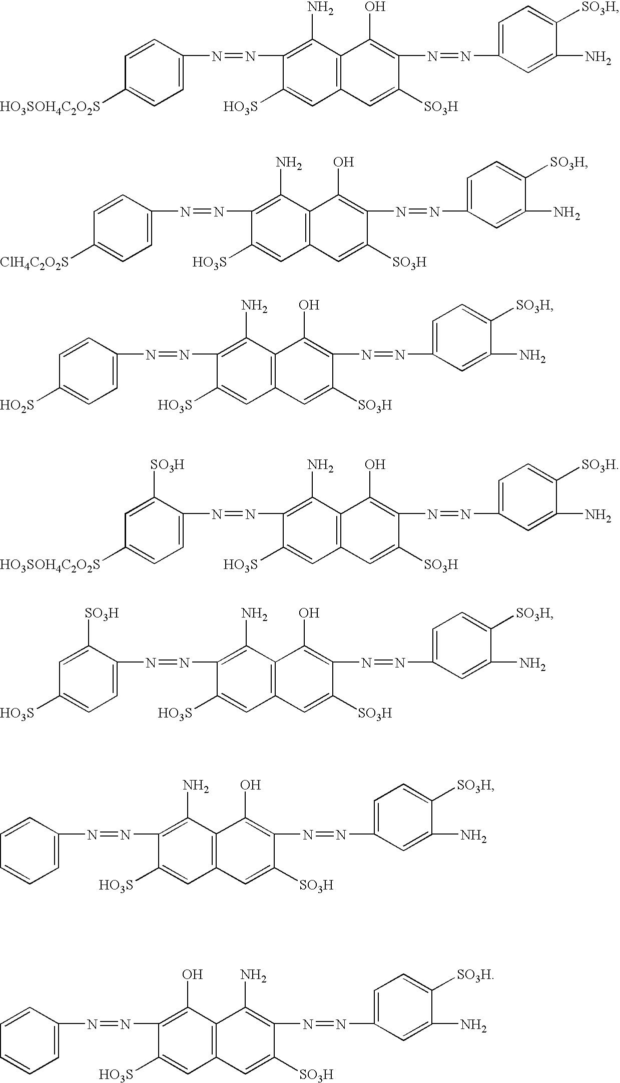

Examples of the above formula (c) are as below:
1-aminobenzene-2-sulfonic acid, 1-aminobenzene-3-sulfonic acid, 1-aminobenzene-4-sulfonic acid, 4-chloro-1-aminobenzene-3-sulfonic acid, 6-chloro-1-aminobenzene-3-sulfonic acid, 1-aminobenzene-2-carboxyl acid, 1-aminobenzene-3-carboxyl acid, 1-aminobenzene-4-carboxyl acid, 1-aminobenzene-3,5-dicarboxyl acid, 2-carboxy-1-aminobenzene-4-sulfonic acid, 2-carboxy-1-aminobenzene-5-sulfonic acid, 4-hydroxy-1-aminobenzene-3-sulfonic acid, 3-hydroxy-1-aminobenzene-4-sulfonic acid, aniline, 2-nitroaniline, 3-nitroaniline, 4-nitroaniline, 2,4-dinitroaniline, 2-chloroaniline, 3-chloroaniline, 4-chloroaniline, 2-bromoaniline, 3-bromoaniline, 4-bromoaniline, 2-methyl-1-aminobenzene-4-sulfonic acid, 4-methyl-1-aminobenzene-2-sulfonic acid, 2-ethyl-1-aminobenzene-5-sulfonic acid, 2-methylaniline, 3-methylaniline, 4-methylaniline, 2,5-dimethylaniline, 2-ethylaniline, 3-ethylaniline, 4-ethylaniline, N-methylaniline, N-ethylaniline, 3-methyl-4-nitro-N-ethylaniline, 2-methyl-5-nitro-N-ethylaniline, 1-aminobenzene-2,4-disulfonic acid, 1-aminobenzene-2,5-disulfonic acid, 4-methoxy-1-aminobenzene-2-sulfonic acid, 2-methoxy-1-aminobenzene-4-sulfonic acid, 4-methoxy-1-aminobenzene-3-sulfonic acid, 2-methoxy-1-aminobenzene-5-sulfonic acid, 4-ethoxy-1-aminobenzene-2-sulfonic acid, 4-ethoxy-1-aminobenzene-3-sulfonic acid, 2-methoxy-1-aminobenzene, 3-methoxy-1-aminobenzene, 4-methoxy-1-aminobenzene, 4-nitro-1-aminobenzene-3-sulfonic acid, 2-nitro-1-aminobenzene-3-sulfonic acid, 5-nitro-1-aminobenzene-2-sulfonic acid, 3-nitro-1-aminobenzene-5-sulfonic acid, 3-nitro-1-aminobenzene-4-sulfonic acid, 2-nitro-1-aminobenzene-4-sulfonic acid, 4-nitro-1-aminobenzene-2-sulfonic acid, 4-acetylamino-1-aminobenzene, 2-acetylamino-1-aminobenzene, 3-acetylamino-1-aminobenzene, 5-acetylamino-2-chloroaniline, 5-acetylamino-2-methylaniline, 3-acetylamino-4-methylaniline, 4-acetylamino-2-methoxyaniline, 4-acetylamino-3-methoxyaniline, 5-acetylamino-2-methoxyaniline, 5-acetylamino-2-methoxy-N-methylaniline, 5-acetylamino-2-ethoxyaniline, 2-acetylamino-5-ethoxyaniline, 4-acetylamino-2-nitroaniline, 2-acetylamino-5-nitroaniline, 4-acetylamino-2-carboxyaniline, 4-acetylamino-3-carboxyaniline, 5-acetylamino-3-carboxyaniline, 4-acetylamino-1-aminobenzene-2-sulfonic acid), 4-acetylamino-1-aminobenzene-3-sulfonic acid, 5-acetylamino-1-aminobenzene-2-sulfonic acid, 3-ureidoaniline, 4-amino-2-(2-carboxy) ethylamino benzene sulfonic acid, 1-aminobenzene-4-β-sulfatoethylsulfone, 1-aminobenzene-3-β-sulfatoethylsulfone, 1-aminobenzene-4-β-chloroethylsulfone, 1-aminobenzene-4-vinylsulfone, aminoacetic acid, 2-aminonaphthalene-1-sulfonic acid, 4-aminonaphtalene-1-sulfonic acid, 5-aminonaphthalene-1-sulfonic acid, 6-aminonaphthalene-1-sulfonic acid, 7-aminonaphthalene-1-sulfonic acid, 8-aminonaphthalene-1-sulfonic acid, 1-aminonaphthalene-2-sulfonic acid, 4-aminonaphthalene-2-sulfonic acid, 5-aminonaphthalene-2-sulfonic acid, 6-aminonaphthalene-2-sulfonic acid, 7-aminonaphthalene-2-sulfonic acid, 7-methylaminonaphthalene-2sulfonic acid, 7-ethylaminonaphthalene-2-sulfonic acid, 7-butylaminonaphthalene-2-sulfonic acid, 7-isobutylaminonaphthalene-2-sulfonic acid, 8-aminonaphthalene-2-sulfonic acid, 4-aminonaphthalene-1,3-disulfonic acid, 5-aminonaphthalene-1,3-disulfonic acid, 6-aminonaphthalene-1,3-disulfonic acid, 7-aminonaphthalene-1,3-disulfonic acid, 8-aminonaphthalene-1,3-disulfonic acid, 2-aminonaphthalene-1,5-disulfonic acid, 3-aminonaphthalene-1,5-disulfonic acid, 4-aminonaphthalene-1,5-disulfonic acid, 4-aminonaphthalene-1,6-disulfonic acid, 8-aminonaphthalene-1,6-disulfonic acid, 4-aminonaphthalene-1,7-disulfonic acid, 3-aminonaphthalene-2,6-disulfonic acid, 4-aminonaphthalene-2,6-disulfonic acid, 3-aminonaphthalene-2,7-disulfonic acid, 4-aminonaphthalene-2,7-disulfonic acid, 6-aminonaphthalene-1,3,5-trisulfonic acid, 7-aminonaphthalene-1,3,5-trisulfonic acid, 4-aminonaphthalene-1,3,6-trisulfonic acid, 7-aminonaphthalene-1,3,6-trisulfonic acid, 8-aminonaphthalene-1,3,6-trisulfonic acid, 4-aminonaphthalene-1,3,7-trisulfonic acid, etc.

The dyestuff of the present invention can be produced by the above methods, reaction conditions are fully described in the above description. Known processes such as spray drying, precipitation, or filtration can purify the dyestuff of the present invention. They can be in the form of powder, granules, particle or liquid and an auxiliary reagent, for example, retarding agent, leveling agent, assistant agent, surfactant agent, or dispersing agent may be added.

The dyestuffs of the present invention all contain at least one anionic group, such as a sulfo group. For convenience they are expressed as free acid in the specification. When the dyestuffs of the present invention are manufactured, purified or used, they often exist in the form of water soluble salts, especially the alkaline metal salts, such as the sodium salt, lithium salt, potassium salt or ammonium salt, preferably sodium salt.

The composition of the present invention can be prepared in several ways. For example, the dye components can be prepared separately and then mixed together to make powder, granular and liquid forms, or a number of individual dyes may be mixed according to the dyeing recipes in a dyehouse. The dye mixtures of the present invention can be prepared, for example, by mixing the individual dyes. The mixing process is carried out, for example, in a suitable mill, such as a ball mill or a pin mill, or kneaders or mixers.

The dyestuff according to the present invention can be applied to dye or print fiber materials, especially cellulose fiber or materials containing cellulose. All natural and regenerated cellulose fiber (e.g. cotton, linen, jute, ramie fiber, viscose rayon) or fiber materials containing cellulose are the materials to which the dyestuff of the present invention can be applied. The dyestuff according to the present invention is also suitable for dyeing or printing fibers, which contain hydroxyl groups and are contained in blended fabrics.

The dyestuff according to the present invention can be applied to the fiber material and fixed on the fiber in various ways, in particular in the form of aqueous dyestuff solutions and printing pastes. They can be applied to cellulose fibers by general dyeing methods, such as exhaustion dyeing, continuous dyeing, cold-pad-batch dyeing or printing that are commonly used in the dyeing of reactive dyestuffs.

The dyestuff according to the present invention is distinguishable from others by qualities such as environmental protection, low salt, and low base, good fixing property and good build-up property. Nevertheless, the present invention also enhances the dye solubility with a high exhaustion. The dyes of the present invention can be applied in a wide range of dyeing temperature; therefore the dyes are also suitable for dyeing cotton and blending polyester fabrics. Printing can also be used with the dyestuff of the present invention. Printing is most suitable for cotton, blends of wool and silk, and T/C one-way bath dyeing.

The dyestuff according to the present invention exhibits superior substantivity, levelness, migration properties, and high fibers/dyes stability in acid/base in dyeing and printing cellulose fiber materials. Besides, the dyed cellulose fiber materials have good properties of light fastness, perspiration-light fastness, and wet fastness, e.g. clean fastness, water fastness, sea water fastness, cross-dyeing fastness, and perspiration fastness, as well as fastness of wrinkling, ironing, and chlorine bleaching.

Many examples have been used to illustrate the present invention. The examples sited below should not be taken as a limit to the scope of the invention. In these examples, the compounds are represented in the form of dissolved acid. However, in practice, they will exist as alkali salts for mixing and salts for dyeing.

In the following examples, quantities are given as parts by weight (%) if there is no indication. The relationship between weight parts and volume parts are the same as that between kilogram and liter.

### PREPARATION EXAMPLE 1

15 parts of 1-amino-8-naphthol-3,6-disulfonic acid are dissolved in 280 parts of water. For fully dissolve of 1-amino-8-naphthol-3,6-disulfonic acid, the pH of the solution is adjusted to 7.0˜7.2 by adding 45% NaOH solution into the above solution. Then 7.6 parts of acetic anhydride is added and stirred at 15 to 30° C. until the acetylation reaction is completed.

13.5 parts of 2-naphthylamino-1-sulfonic acid and 4.6 parts of sodium nitrite are dissolved in 150 parts of water, then it is further added into a solution that consists of 300 parts of ice water and 35.5 parts of 32% HCl solution. The mixture is subsequently stirred at room temperature until the diazotization reaction is completed. Follow-up to this mixture, the aforementioned acetylated solution is added and stirred at room temperature until the coupling reaction is completed. The reaction mixture is further stirred for two hours at 70 to 80° C. while the pH is kept at 10-13 by adding dropwise a 45% NaOH solution for deacetylation reaction to complete. Lastly NaCl is added, and a pH of 6.8-7.2 is maintained with 32% HCl solution. Compound (P-1) is obtained after filtration.

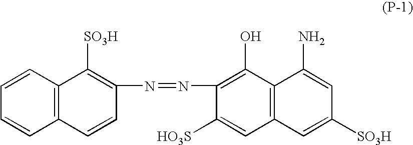

### EXAMPLE 1

24.4 parts of compound (P-1) are dissolved in 500 parts of ice water, and then 8.35 parts of cyanuric chloride are further added. The pH of the solution is adjusted to 6.5-7.0 by the addition of sodium carbonate solution(aq), meanwhile the solution is stirred under 0 to 10° C. for an hour until the reaction is completed. To the reaction mixture solution, a powder of 8.65 parts of 1-aminobenzene-3-sulfonic acid is added, which is then heated to 35° C. with a pH of the solution being maintained at 6.0-6.5 until the reaction is completed. Then 8.12 parts of nicotinic acid is subsequently added, and the heating temperature is further increased to 85-100° C. while a pH of 5.5 is maintained until the reaction is completed; Compound (1) can be obtained after salting out and then filtration.

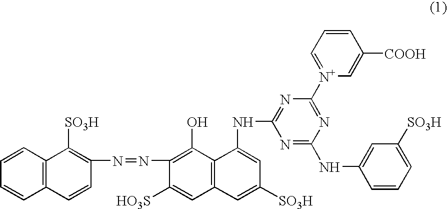

### EXAMPLES 2 TO 9

The same procedures as in example 1 were repeated, but this time 1-amino benzene-3-sulfonic acid is replaced with the substituting compounds showing as below to proceed with the reaction. Red reactive dyestuffs could be obtained.

| Example No. | Substituting compound |
|---|---|
| Example 2 | 1-aminobenzene-4-sulfonic acid |
| Example 3 | 3-urea aniline |
| Example 4 | N-ethyl aniline |
| Example 5 | 1-aminobenzene-2-carboxyl acid |
| Example 6 | 4-methoxy-1-aminobenzene-2-sulfonic acid |
| Example 7 | 4-methoxy-1-aminobenzene |
| Example 8 | 4-acetylamino-1-aminobenzene-2-sulfonic acid |
| Example 9 | 4-amino-2-(2-carboxy) ethylamino benzene sulfonic acid |

### EXAMPLE 10

19.17 parts of 7-aminonaphthalene-1,3,6-tri-sulfonic acid are dissolved by addition of 70 parts of water. For fully dissolve of 7-aminonaphthalene-1,3,6-tri-sulfonic acid, the pH of the solution is adjusted to 7.0-7.5 by adding approximately 5 parts of soda ash into the above solution. Subsequently 3.6 parts of sodium nitrite is further added and stirred for 10 minutes, which are then chilled to 0˜2° C. by addition of ice. The aforementioned solution is added dropwise to an icy acidic solution within 30 minutes, then it is maintained at 5˜8° C. and stirred for 40 minutes. Afterwards, 0.6 parts of achromatic agent is added and again stirred for 10 minutes, then the solution is allowed to cool to 5° C.

7.56 parts of 3-ureidoaniline is dissolved in 50 parts of water. For fully dissolve of 3-ureidoaniline, the temperature is elevated to 55° C. and the pH is adjusted to 7.0 by adding 3 parts of sodium carbonate into the above solution. The solution is then chilled to 20˜25° C. by addition of ice for depositing; subsequently it is added within 20-30 minutes to the aforementioned diazonium salt solution, meanwhile the temperature and pH are maintained at 8˜10° C. and 4.0 respectively. In addition, 15% sodium carbonate solution (aq) is then added dropwise for an hour to adjust the pH to 5.0-5.5, after the solution is stirred for 20 minutes and cooled to 5° C.

9.22 parts of cyanuric chloride is mixed with ice water for 20 minutes, and it is further added to the aforementioned solution; under 5-8° C, 15% sodium carbonate solution (aq) is subsequently added dropwise for an hour until the pH is adjusted to 5.0-5.5. Thereafter, the solution is stirred for 20 minutes and filtered with diatomaceous earth to obtain a filtrate. 6.85 parts of 2-amninobenzoic acid are then added to the reactant solution, and the resulting mixture is heated and maintained at 45° C., also a pH of 6.0-6.5 is adjusted and maintained by the addition of sodium bicarbonate, the resulting mixture is stirred until the reaction is completed. Follow-up, 9.22 parts of nicotinic acid are added, and the resulting mixture is heated to 85-100° C. while the pH is maintained at 5.5; upon reaction completion formula (10) compound can be obtained after salting out and filtration.

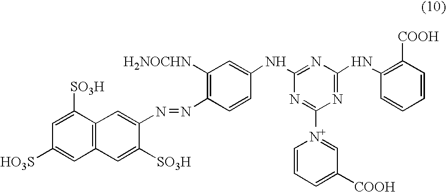

### EXAMPLES 11 TO 21

The same procedures as in example 10 were repeated, but this time 7-aminonaphthalene-1,3,6-trisulfonic acid is replaced with the amino naphthalene compounds in column two showing as below, and 2-aminobenzoic acid is replaced with the aromatic amino compounds in column three showing as below to obtain the desired yellow reactive dyes.

| Example | amino naphthalene | aromatic amino | |
|---|---|---|---|
| # | compounds | compounds | Notes |
| 11 | 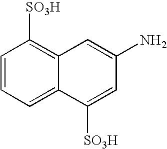 | 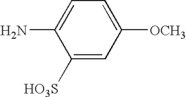 | |
| 12 | 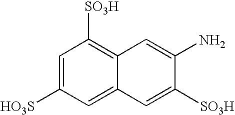 | 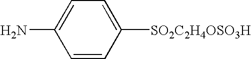 | |
| 13 | 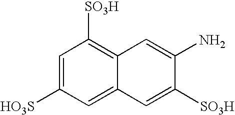 | 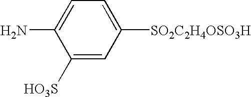 | |
| 14 | 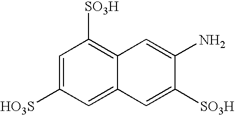 | 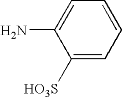 | |
| 15 | 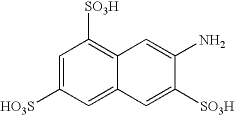 | 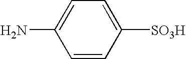 | |
| 16 | 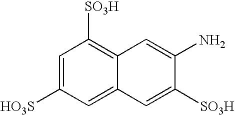 | 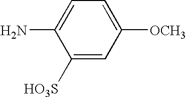 | |
| 17 | 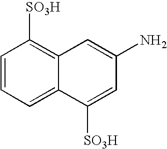 | 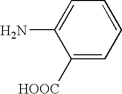 | |
| 18 | 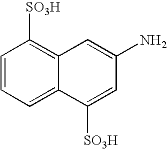 | 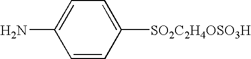 | |
| 19 | 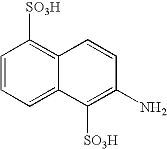 | 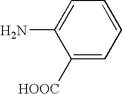 | |
| 20 | 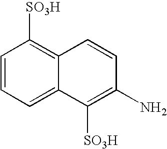 | 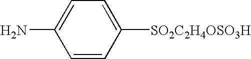 | |
| 21 | 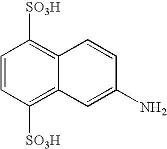 | 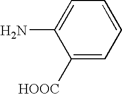 | |

### EXAMPLE 22

9.4 parts of 2,4-diamino-1-benzene sulfonic acid are dissolved in 100 parts of water, where sodium carbonate is also applied for adjusting the pH of the resulting solution to 5.0-5.7. The aforementioned resulting solution is then added slowly to a solution consisting of 9.31 parts of cyanuric chloride and 100 parts of ice water, under 0-5° C., 15% sodium carbonate solution (aq) is utilized to adjust the pH to 5.0˜6.5, thereafter, the solution is stirred until the reaction is completed. 8.65 parts of 3-aminobenzenesulfonic acid is added to the reactant solution, the temperature is elevated and maintained at 35˜40° C., also the pH is adjusted and maintained at 5.0-6.5 by the addition of sodium bicarbonate, thereafter, the solution is stirred until the reaction is completed. The temperature of the resulting solution is chilled to 0-5° C. by the addition of ice, soon after, 3.55 parts of sodium nitrite is added and stirred for 10 minutes, and rapidly 16.2 parts of 32% HCl(aq) is further added and stirred for 30 minutes under 10˜15° C. Lastly, 0.6 parts of achromatic agent is added and stirred for 10 minutes. 15.79 parts of 1-amino-8-hydoxynaphthyl-3,6- disulfonic acid is added to the reactant solution, where sodium carbonate is used to adjust the pH of the resulting solution to 2.5-3.0, then the resulting solution is stirred until the reaction is completed. 11.34 parts diazonium salt solution of 2-aminonaphthalene sulfonic acid is added to the reactant solution where sodium carbonate is used to adjust the pH to 8.0-8.5, and again the solution is stirred until the reaction is completed. Continue with the resulting solution, where 9.3 parts of nicotinic acid is further added, which is then heated to 85˜100° C. with the pH being maintained at 5.0˜5.5 until the reaction is completed. Compound (22) can be obtained after salting out and filtration.

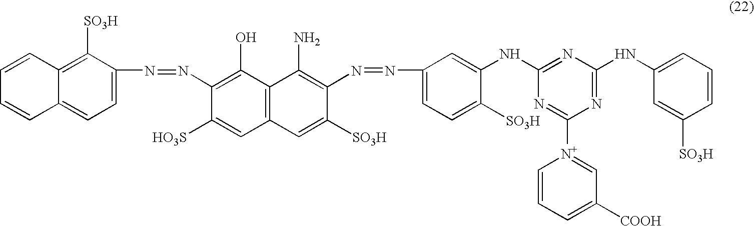

### EXAMPLE 23

The same procedures as in example 22 were repeated, but this time 3-aminobenzenesulfonic acid is replaced with 3-urea aniline compound and 2-aminonaphthlene sulfonic acid is replaced with 1-aminobenzene-4-βsulfatoethylesulfone to proceed with the reaction. The desired mazarine reactive dye(23) could be obtained.

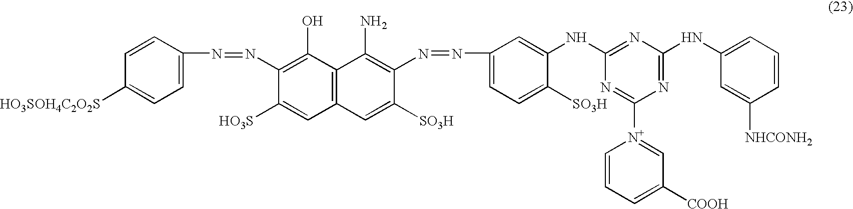

### EXAMPLES 24 TO 37

The same procedures as in example 22 were repeated to synthesize following dyestuff compounds:

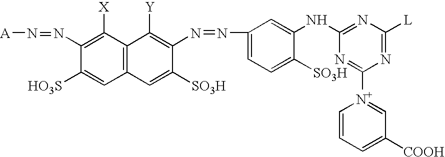

The functional groups of which A, X, Y, L represents is shown in the table below.

| Example | | | | |
|---|---|---|---|---|
| # | A | X | Y | L |
| 24 | 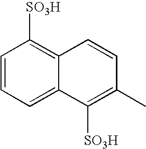 | OH | NH₂ | 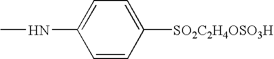 |
| 25 | 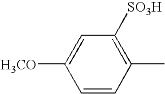 | OH | NH₂ | 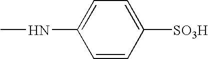 |
| 26 | 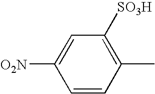 | OH | NH₂ | 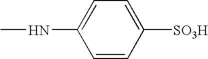 |
| 27 | 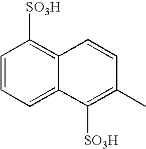 | OH | NH₂ | 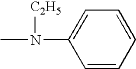 |
| 28 | 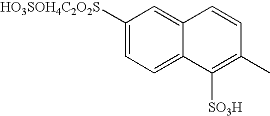 | OH | NH₂ | 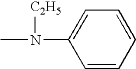 |
| 29 | 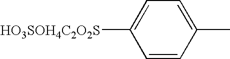 | OH | NH₂ | 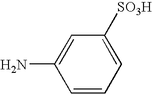 |
| 30 | 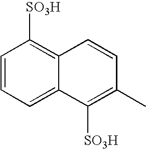 | NH₂ | OH | 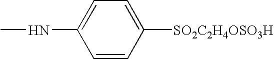 |
| 31 | 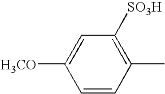 | NH₂ | OH | 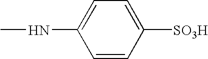 |
| 32 | 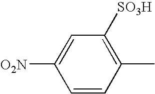 | NH₂ | OH | 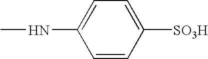 |
| 33 | 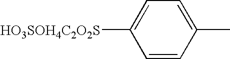 | NH₂ | OH | 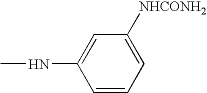 |
| 34 | 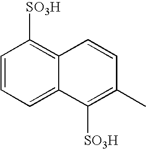 | NH₂ | OH | 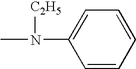 |
| 35 | 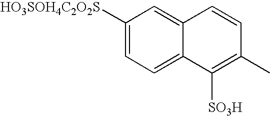 | NH₂ | OH | 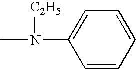 |
| 36 | 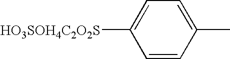 | NH₂ | OH | 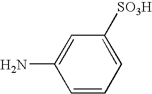 |
| 37 | 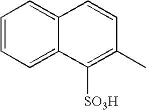 | NH₂ | OH | 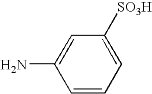 |

### EXAMPLE 38

First of all, 100 parts of urea, 10 parts of anti-reductive agent, 20 parts of sodium bicarbonate, 55 parts of sodium alginate, and 815 parts of warm water are mixed together to form 1000 parts of printing paste. Obtain 3 parts of the dye made from example 1 and to 100 parts of the aforesaid printing paste it is sprinkled on top of, and vigorously stirred.

A 45 degree stamp of the 100 mesh is used to cover on top of an appropriate size mercerize cotton twill cloth, and further treated with colored paste, then dry the processed cloth into an oven at 65° C. for 5 minutes. Afterwards the cloth is putted into a 102˜105° C. steam chamber with saturated vapor at 1 atmosphere for 10 minutes. Subsequently, the obtained red dyed cloth is washed with cold water, boiled hot water for 10 minutes, boiled non-ionic cleaning agent for 10 minutes, and washed again with cold water. After the red dyed cloth is dried it exhibits superb properties.

### EXAMPLE 39

3 parts of the dye obtained according to example 1 are dissolved in 100ml of water to prepare a 30 parts/L of dye solution; a base agent (caustic sodium 38°Be′ 15 ml/L and Glauber's salt 30 parts/L) is added and stirred vigorously into the dye solution (base agent: dye solution=1:4); the obtained mixed solution is then poured into the roller printing machine, and a cloth is then inserted into the roller printing machine. The printed cloth is curled up as a scroll and stored at room temperature. After 4 hours, the cloth is washed sequentially with cold water, boiled hot water for 10 minutes, boiled non-ionic cleaning agent for 10 minutes, and again washed with cold water; the red dyed cloth is then dried to obtain a red dyed cloth with superb properties.

### EXAMPLE 40

0.25 parts of the dye obtained according to example 1 are dissolved in 250 ml of water to prepare a dye solution (0.1%). To 40 ml of the dye solution (0.1%), in a dyeing bottle, is added 2 parts of cotton cloth, 2.4 parts of Glauber's salt, and 2.5 ml of 32% sodium carbonate solution; the dyeing bottle is then putted into an oscillating dye machine at 50° C. for 60 minutes. Afterwards, the obtained red dyed cloth is washed sequentially with cold water, boiled hot water for 10 minutes, boiled non-ionic cleaning agent for 10 minutes, and again washed with cold water; the red dyed cloth is dried and a red dyed cloth with superb properties is obtained.

### EXAMPLE 41

0.25 parts of the dye obtained according to example 10 is dissolved in 250 ml of water to produce dye solution (0.1%). To 40 ml of dye solution (0.1%), in a dyeing bottle, is added 2 parts of cotton cloth, 2.4 parts of Glauber's salt, and 2.5 ml of 32% sodium carbonate solution; the dyeing bottle is then putted into an oscillating dye machine at 50° C. for 60 minutes. Afterwards, the obtained yellow dyed cloth is sequentially washed with cold water, boiled hot water for 10 minutes, boiled non-ionic cleaning agent for 10 minutes, and again washed with cold water. The yellow dyed cloth is dried and a yellow dyed cloth with superb properties is obtained.

### EXAMPLE 42

0.25 parts of the dye obtained accordingly to example 22 is dissolved in 250 ml of water to prepare a dye solution (0.1%). To 40 ml of the dye solution (0.1%), in a dyeing bottle, is added 2 parts of cotton cloth, 2.4 parts of Glauber's salt, and 2.5 ml of 32% sodium carbonate solution; the dyeing bottle is then putted into an oscillating dye machine at 50° C. for 60 minutes. Afterwards, the obtained mazarine dyed cloth is washed sequentially with cold water, boiled hot water for 10 minutes, boil non-ionic cleaning agent for 10 minutes, and again washed with cold water. The obtained mazarine dyed cloth is dried, and a mazarine dyed cloth with superb properties is obtained.

### EXAMPLE 43

0.49 parts dyestuff of formula (1), 0.33 parts dyestuff of formula (10), 0.18 parts dyestuff of formula (22) are prepared and mixed with 1000 ml of water to form a dye solution (0.1%); to 40 ml of dye solution (0.1%), in a dyeing bottle, is added 2 parts of cotton cloth, 2.4 parts of Glauber's salt, and 2.5 ml of 32% sodium carbonate solution; the dyeing bottle is then putted into an oscillating dye machine at 50° C. for 60 minutes. Afterwards, the obtained brown dyed cloth is washed sequentially with cold water, boiled hot water for 10 minutes, boiled non-ionic cleaning agent for 10 minutes, and washed again with cold water. After the brown dyed cloth is dried, a brown dyed cloth with superb properties is obtained.

The environmental protection series of reactive dyestuffs of the present invention is an universal dye composition, suitable for the dyeing of cellulose fiber materials; in application it can be use as common reactive dyes, such as in exhaust dyeing, printing, and continuous dyeing. Moreover, the product dyed with the dyestuffs exhibit superior properties.

The environmental protection series of reactive dyestuffs of the present invention are water-soluble dyestuffs that have a highly commercial value. The dyestuff of the present invention can obtained dyeing results with excellent properties in all aspects, especially in washing off, build-up, levelness, wash fastness, light fastness, rubbing fastness, ironing fastness, and chlorine bleaching fastness.

Although the present invention has been explained in relation to its preferred embodiment, it is to be understood that many other possible modifications and variations can be made without departing from the scope of the invention as hereinafter claimed.

1. A reactive dyestuff of the following formula (I) 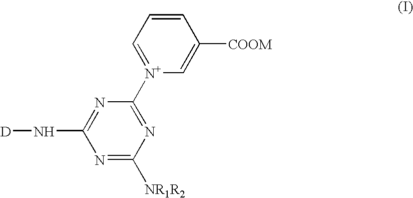
wherein:
R₁ is H, C₁₋₄ alkyl, a phenyl group unsubstituted or substituted by one or more substituents, or a naphthyl group unsubstituted or substituted by one or more substituents;
R₂ is H, C₁₋₄ alkyl, a phenyl group unsubstituted or substituted by one or more substituents, or a naphthyl group unsubstituted or substituted by one or more substituents;
M is H or an alkali metal;
D is a chromophore selected from the group consisting of: 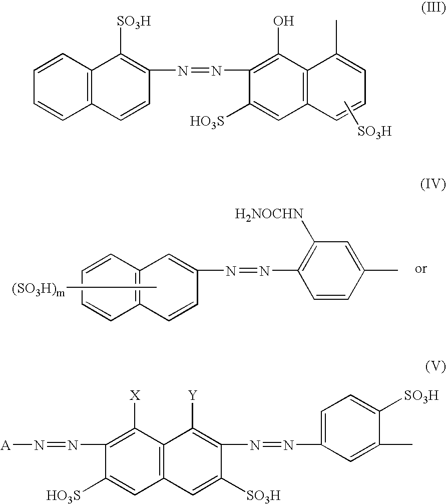
m is 2 or 3;
X and Y are different and each is independently amino group or hydroxyl group,
A is 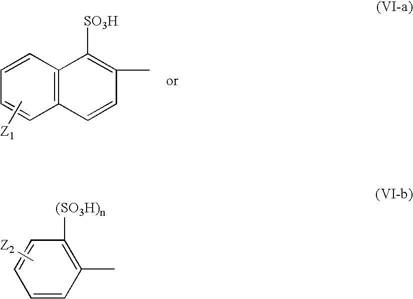
Z₁ is H, sulfo group, —SO₂CH═CH₂, —SO₂CH₂CH₂OSO₃H, or —SO₂CH₂CH₂Cl;
Z₂ is H, nitro group, methoxyl group, sulfo group, —SO₂CH═CH₂, —SO₂CH₂CH₂OSO₃H, or —SO₂CH₂CH₂Cl;
n is 0 or 1.

2. The reactive dyestuff of claim 1, wherein R₁ is H or C₁₋₄ alkyl, R₂ is a phenyl group unsubstituted or substituted by one or more substituents.

3. The reactive dyestuff of claim 2, wherein R₂ is a phenyl group unsubstituted or substituted by one or more substituents selected from the group consisting of carboxyl group, sulfo group, —NHCOCH₃, —NHCONH₂, —NHCH₂CH₂COOH, methoxyl group, —SO₂CH═CH₂, —SO₂CH₂CH₂OSO₃H, or —SO₂CH₂CH₂Cl.

4. The reactive dyestuff of claim 2, wherein R₂ is a phenyl group unsubstituted or substituted by one or more substituents selected from the group consisting of carboxyl group, sulfo group, —NHCONH₂, or —SO₂CH₂CH₂OSO₃H.

5. The reactive dyestuff of claim 1, wherein the formula (I) is the following formula (Ia) 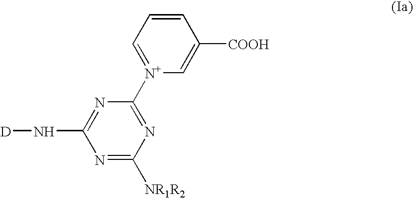
R₁ is H, C₁₋₄ alkyl, a phenyl group unsubstituted or substituted by one or more substituents, or a naphthyl group unsubstituted or substituted by one or more substituents;
R₂ is H, C₁₋₄ alkyl, a phenyl group unsubstituted or substituted by one or more substituents, or a naphthyl group unsubstituted or substituted by one or more substituents;
D is a chromophore selected from the group consisting of: 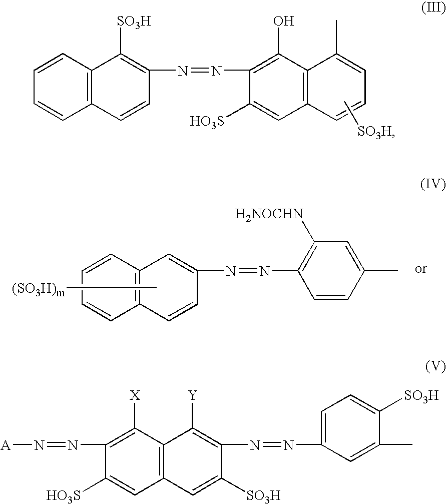
m is 2 or 3;
X and Y are different and each is independently amino group or hydroxyl group,
A is 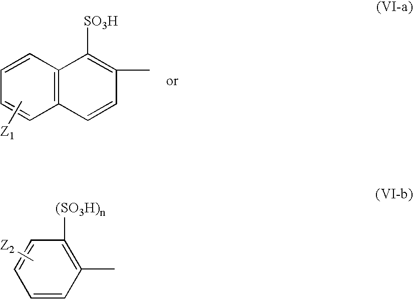
Z₁ is H, sulfo group, —SO₂CH═CH₂, —SO₂CH₂CH₂OSO₃H, or —SO₂CH₂CH₂Cl;
Z₂ is H, nitro group, methoxyl group, sulfo group, —SO₂CH═CH₂, —SO₂CH₂CH₂OSO₃H, or —SO₂CH₂CH₂Cl;
n is 0 or 1.

6. The reactive dyestuff of claim 5, wherein R₁ is H or C₁₋₄ alkyl, R₂ is a phenyl group unsubstituted or substituted by one or more substituents.

7. The reactive dyestuff of claim 6, wherein R₂ is a phenyl group unsubstituted or substituted by one or more substituents selected from the group consisting of carboxyl group, sulfo group, —NHCOCH₃, —NHCONH₂, —NHCH₂CH₂COOH, methoxyl group, —SO₂CH═CH₂, —SO₂CH₂CH₂OSO₃H, or —SO₂CH₂CH₂Cl.

8. The reactive dyestuff of claim 6, wherein R₂ is a phenyl group unsubstituted or substituted by one or more substituents selected from the group consisting of carboxyl group, sulfo group, —NHCONH₂, or —SO₂CH₂CH₂OSO₃H.

9. The reactive dyestuff of claim 1, wherein the formula (I) is the following formula (Ib) 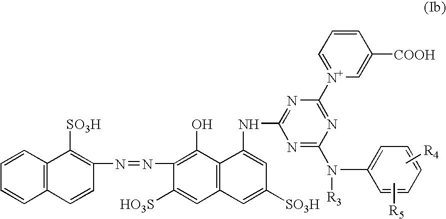
wherein:
R₃ is H or C₁₋₄ alkyl;
R₄ and R₅ each independently is H, methyl, ethyl, methoxyl, ethoxyl, chloro, bromo, nitro, carboxyl, sulfo, —NHCOCH₃, —NHCONH₂ or —NHCH₂CH₂COOH.

10. The reactive dyestuff of claim 9, wherein R₃ is H.

11. The reactive dyestuff of claim 9, wherein R₄ and R₅ each independently is H, methyl, methoxyl, ethoxyl, carboxyl, sulfo, —NHCOCH₃, —NHCONH₂ or —NHCH₂CH₂COOH.

12. The reactive dyestuff of claim 9, wherein the formula (Ib) is the following formula (1)

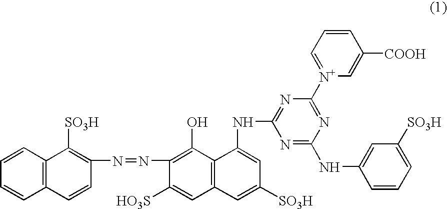

13. The reactive dyestuff of claim 1, wherein the formula (I) is the following formula (Ic) 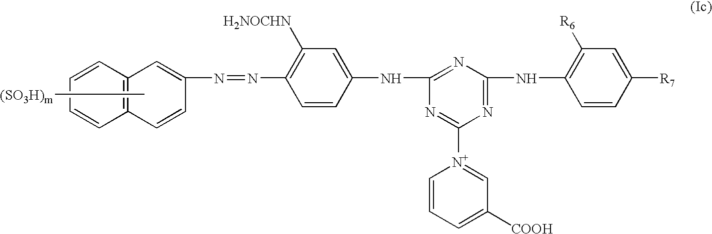
wherein:
R₆ is H, carboxyl group, sulfo group, —NHCOCH₃, —NHCONH₂ or —NHCH₂CH₂COOH;
R₇ is H, methoxyl group, sulfo group, —SO₂CH═CH₂, —SO₂CH₂CH₂OSO₃H or —SO₂CH₂CH₂Cl;
m is 2 or 3.

14. The reactive dyestuff of claim 13, wherein R₆ is H, carboxyl group, sulfo group, or —NHCONH₂.

15. The reactive dyestuff of claim 13, wherein R₇ is H, sulfo group, or —SO₂CH₂CH₂OSO₃H.

16. The reactive dyestuff of claim 13, wherein m is 3.

17. The reactive dyestuff of claim 13, wherein the formula (Ic) is the following formula (10)

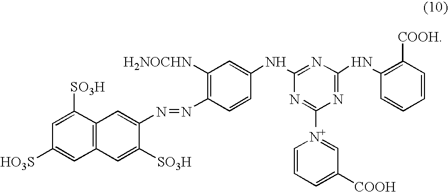

18. The reactive dyestuff of claim 1, wherein the formula (I) is the following formula (Id) 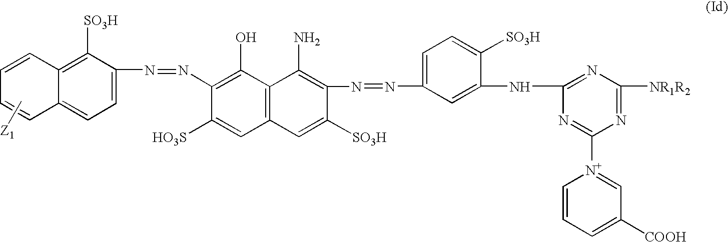
wherein:
R₁ is H, C₁₋₄ alkyl, a phenyl group unsubstituted or substituted by one or more substituents, or a naphthyl group unsubstituted or substituted by one or more substituents;
R₂ is H, C₁₋₄ alkyl, a phenyl group unsubstituted or substituted by one or more substituents, or a naphthyl group unsubstituted or substituted by one or more substituents;
Z₁ is H, sulfo group, —SO₂CH═CH₂, —SO₂CH₂CH₂OSO₃H or —SO₂CH₂CH₂Cl.

19. The reactive dyestuff of claim 18, wherein R₁ is H or C₁₋₄ alkyl, R₂ is a phenyl group unsubstituted or substituted by one or more substituents.

20. The reactive dyestuff of claim 19, wherein R₂ is a phenyl group unsubstituted or substituted by one or more substituents selected from the group consisting of carboxyl group, sulfo group, —NHCOCH₃, —NHCONH₂, —NHCH₂CH₂COOH, methoxyl group, —SO₂CH═CH₂, —SO₂CH₂CH₂OSO₃H, or —SO₂CH₂CH₂Cl.

21. The reactive dyestuff of claim 19, wherein R₂ is a phenyl group unsubstituted or substituted by one or more substituents selected from the group consisting of carboxyl group, sulfo group, —NHCONH₂, or —SO₂CH₂CH₂OSO₃H.

22. The reactive dyestuff of claim 18, wherein Z, is H, sulfo group, or —SO₂CH₂CH₂OSO₃H.

23. The reactive dyestuff of claim 18, wherein the formula (Id) is the following formula (22)

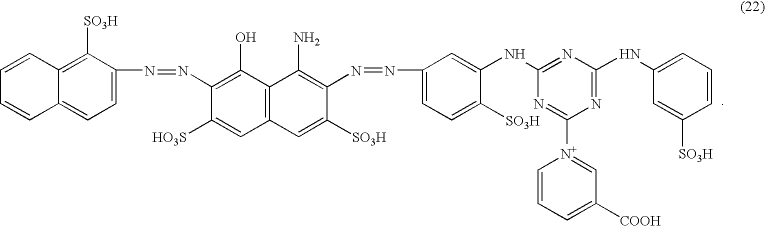

24. The reactive dyestuff of claim 1, wherein the formula (I) is the following formula (Ie). 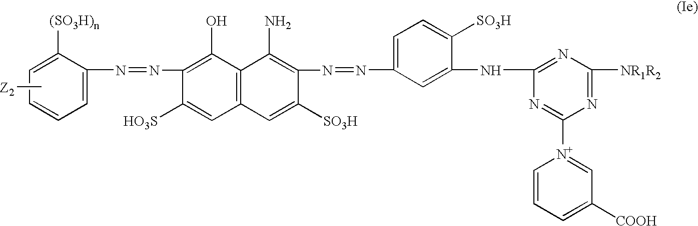
R₁ is H, C₁₋₄ alkyl, a phenyl group unsubstituted or substituted by one or more substituents, or a naphthyl group unsubstituted or substituted by one or more substituents;
R₂ is H, C₁₋₄ alkyl, a phenyl group unsubstituted or substituted by one or more substituents, or a naphthyl group unsubstituted or substituted by one or more substituents;
Z₂ is H, nitro group, methoxyl group, sulfo group, —SO₂CH═CH₂, —SO₂CH₂CH₂OSO₃H, or —SO₂CH₂CH₂Cl;
n is 0 or 1.

25. The reactive dyestuff of claim 24, wherein R₁ is H or C₁₋₄ alkyl, R₂ is a phenyl group unsubstituted or substituted by one or more substituents.

26. The reactive dyestuff of claim 25, wherein R₂ is a phenyl group unsubstituted or substituted by one or more substituents selected from the group consisting of carboxyl group, sulfo group, —NHCOCH₃, —NHCONH₂, —NHCH₂CH₂COOH, methoxyl group, —SO₂CH═CH₂, —SO₂CH₂CH₂OSO₃H, or —SO₂CH₂CH₂Cl.

27. The reactive dyestuff of claim 25, wherein R₂ is a phenyl group unsubstituted or substituted by one or more substituents selected from the group consisting of carboxyl group, sulfo group, —NHCONH₂, or —SO₂CH₂CH₂OSO₃H.

28. The reactive dyestuff of claim 24, wherein the Z₂ is H, sulfo group, or —SO₂CH₂CH₂OSO₃H.

29. The reactive dyestuff of claim 24, wherein n is 0.

30. The reactive dyestuff of claim 24, wherein the formula (Ie) is the following formula (23)

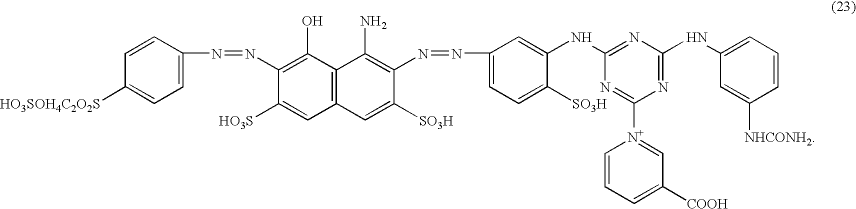

31. A reactive dyestuff composition comprising at least two components selected from the group consisting of the following formula (Ib), (Ic), (Id), and (Ie) 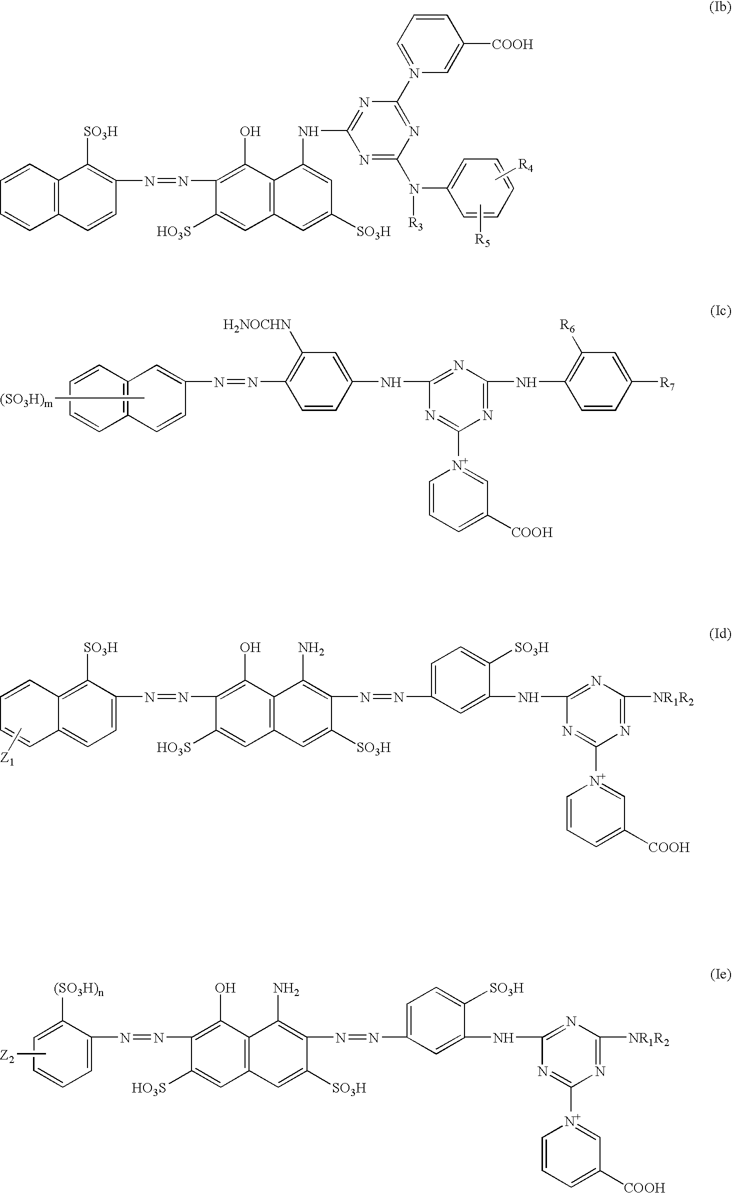
wherein:
R₁ is H, C₁₋₄ alkyl, a phenyl group unsubstituted or substituted by one or more substituents, or a naphthyl group unsubstituted or substituted by one or more substituents;
R₂ is H, C₁₋₄ alkyl, a phenyl group unsubstituted or substituted by one or more substituents, or a naphthyl group unsubstituted or substituted by one or more substituents;
R₃ is H or C₁₋₄ alkyl;
R₄ and R₅ each independently is H, methyl, ethyl, methoxyl, ethoxyl, chloro, bromo, nitro, carboxyl, sulfo, —NHCOCH₃, —NHCONH₂ or —NHCH₂CH₂COOH;
R₆ is H, carboxyl group, sulfo group, —NHCOCH₃, —NHCONH₂ or —NHCH₂CH₂COOH;
R₇ is H, methoxyl group, sulfo group, —SO₂CH═CH₂, —SO₂CH₂CH₂OSO₃H or —SO₂CH₂CH₂Cl;
Z₁ is H, sulfo group, —SO₂CH═CH₂, —SO₂CH₂CH₂OSO₃H, or —SO₂CH₂CH₂Cl;
Z₂ is to H, nitro group, methoxyl group, sulfo group, —SO₂CH═CH₂, —SO₂CH₂CH₂OSO₃H, or —SO₂CH₂CH₂Cl;
m is 2 or 3;
n is 0 or 1.

32. The dyestuff composition of claim 31, wherein R₁ is H or C₁₋₄ alkyl.

33. The dyestuff composition of claim 31, wherein R₂ is a phenyl group unsubstituted or substituted by one or more substituents, or a naphthyl group unsubstituted or substituted by one or more substituents.

34. The dyestuff composition of claim 31, wherein R₃ is H.

35. The dyestuff composition of claim 31, wherein R and R₅ each independently is H, methyl, methoxyl, ethoxyl, carboxyl, sulfo, —NHCOCH₃, —NHCONH₂, or —NHCH₂CH₂COOH.

36. The dyestuff composition of claim 31, wherein R₆ is H, carboxyl group, sulfo group, or —NHCONH₂.

37. The dyestuff composition of claim 31, wherein R₇ is H, sulfo group, or —SO₂CH₂CH₂OSO₃H.

38. The dyestuff composition of claim 31, wherein Z, is H, sulfo group, or —SO₂CH₂CH₂OSO₃H.

39. The dyestuff composition of claim 31, wherein Z₂ is H, sulfo group, or —SO₂CH₂CH₂OSO₃H.

40. The dyestuff composition of claim 31, wherein m is 3.

41. The dyestuff composition of claim 31, wherein n is 0.
